(19) United States
(12) Patent Application Publication
(10) Pub. No.: US 2026/0285069 A1
(43) Pub. Date: Sep. 24, 2026

(54) IMAGE FORMING APPARATUS AND IMAGE FORMING METHOD EACH OF WHICH ALLOWS MOVEMENT RANGE OF COMPONENT TO BE SWITCHED THAT IS USED TO ADJUST POSITION OF SHEET IN WIDTH DIRECTION DEPENDING ON CONVEYANCE INTERVAL BETWEEN SHEETS

(71) Applicant: KYOCERA Document Solutions Inc., Osaka-shi, Osaka (JP)

(72) Inventor: Haruna Takamura, Osaka (JP)

(21) Appl. No.: 19/555,606

(22) Filed: Mar. 3, 2026

(30) Foreign Application Priority Data
Mar. 21, 2025 (JP) 2025-046413

(51) Int. Cl. B41J 13/32; B41J 13/00; B41J 13/02; B41J 13/08

(52) U.S. Cl. CPC B41J 13/32; B41J 13/0018; B41J 13/0027; B41J 13/02; B41J 13/08; B41J 2203/01

(57) ABSTRACT

An image forming apparatus includes a conveying portion, a first movement processing portion, and a second movement processing portion. The conveying portion is provided so as to be movable along a width direction on an upstream side of an image forming position in a conveyance direction of a sheet. The conveying portion nips and conveys the sheet. The first movement processing portion moves the conveying portion that is nipping the sheet from a reference position within a movement range along the width direction around the reference position on the basis of a result of the sensing of a position of the sheet in the width direction. The second movement processing portion moves the conveying portion to the reference position in a non-nipping period in which the conveying portion is not nipping the sheet.

### INCORPORATION BY REFERENCE

This application is based upon and claims the benefit of priority from the corresponding Japanese Patent Application No. 2025-046413 filed on Mar. 21, 2025, the entire contents of which are incorporated herein by reference.

### BACKGROUND

This disclosure relates to an image forming apparatus and an image forming method.

An image forming apparatus that allows the position of a sheet in the width direction which is conveyed to an image forming position to be adjusted has been known.

For example, the image forming apparatus includes a conveying portion, a sensing portion, a first movement processing portion, and a second movement processing portion. The conveying portion is provided so as to be movable along the width direction on the upstream side of the image forming position in the conveyance direction of the sheet. The conveying portion nips and conveys the sheet. The sensing portion senses the position of the sheet in the width direction before the back end of the sheet passes through the conveying portion. The first movement processing portion moves the conveying portion that is nipping the sheet along the width direction from a reference position defined in advance on the basis of a result of the sensing by the sensing portion. The second movement processing portion moves the conveying portion to the reference position in a non-nipping period from the time when the conveying portion finishes nipping the sheet to the time when the conveying portion starts to nip the next sheet.

### SUMMARY

An image forming apparatus according to an aspect of this disclosure includes an image forming portion, a conveying portion, a supply portion, a sensing portion, a first movement processing portion, and a second movement processing portion. The image forming portion forms an image on a sheet. The conveying portion is provided so as to be movable along a width direction on an upstream side of an image forming position by the image forming portion in a conveyance path of the sheet in a conveyance direction of the sheet. The conveyance path extends through the image forming position. The width direction is orthogonal to the conveyance direction. The conveying portion is configured to nip and convey the sheet. The supply portion periodically supplies the sheet to the conveyance path. The sensing portion senses a position of the sheet in the width direction before a back end of the sheet supplied by the supply portion passes through the conveying portion. The first movement processing portion moves the conveying portion that is nipping the sheet from a reference position defined in advance within a movement range along the width direction around the reference position on the basis of a result of sensing by the sensing portion. The second movement processing portion moves the conveying portion to the reference position in a non-nipping period from time when the conveying portion finishes nipping the sheet to time when the conveying portion starts to nip the next sheet. The supply portion periodically supplies the sheet in a designation supply mode designated in advance among a plurality of supply modes having the non-nipping periods different from each other. The first movement processing portion moves the conveying portion that is nipping the sheet from the reference position within the movement range corresponding to the designation supply mode among a plurality of the movement ranges corresponding to a plurality of the supply modes.

An image forming method according to another aspect of this disclosure is executed by an image forming apparatus including an image forming portion, a conveying portion, a supply portion, and a sensing portion. The image forming portion forms an image on a sheet. The conveying portion is provided so as to be movable along a width direction on an upstream side of an image forming position by the image forming portion in a conveyance path of the sheet in a conveyance direction of the sheet. The conveyance path extends through the image forming position. The width direction is orthogonal to the conveyance direction. The conveying portion nips and conveys the sheet. The supply portion periodically supplies the sheet to the conveyance path. The sensing portion senses a position of the sheet in the width direction before a back end of the sheet supplied by the supply portion passes through the conveying portion. The image forming method includes a first movement step and a second movement step. In the first movement step, the conveying portion that is nipping the sheet is moved from a reference position defined in advance within a movement range along the width direction around the reference position on the basis of a result of sensing by the sensing portion. In the second movement step, the conveying portion is moved to the reference position in a non-nipping period from time when the conveying portion finishes nipping the sheet to time when the conveying portion starts to nip the next sheet. The supply portion periodically supplies the sheet in a designation supply mode designated in advance among a plurality of supply modes having the non-nipping periods different from each other. The conveying portion that is nipping the sheet is moved in the first movement step from the reference position within the movement range corresponding to the designation supply mode among a plurality of the movement ranges corresponding to a plurality of the supply modes.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a cross-sectional view of a configuration of an image forming apparatus according to an embodiment of this disclosure.

FIG. 2 is a plan view of a configuration of an image forming portion of the image forming apparatus according to the embodiment of this disclosure.

FIG. 3 is a plan view of a configuration of a correction roller pair of the image forming apparatus according to the embodiment of this disclosure.

FIG. 4 is a block diagram showing a system configuration of the image forming apparatus according to the embodiment of this disclosure.

FIG. 5 is a flowchart showing an example of a first movement control process that is executed by the image forming apparatus according to the embodiment of this disclosure.

FIG. 6 is a flowchart showing an example of a second movement control process that is executed by the image forming apparatus according to the embodiment of this disclosure.

### DETAILED DESCRIPTION

Hereinafter, an embodiment of this disclosure will be described with reference to the accompanying drawings. It is noted that the following embodiment is a specific example of this disclosure and does not limit the technical scope of this disclosure.

### Configuration of Image Forming Apparatus 100

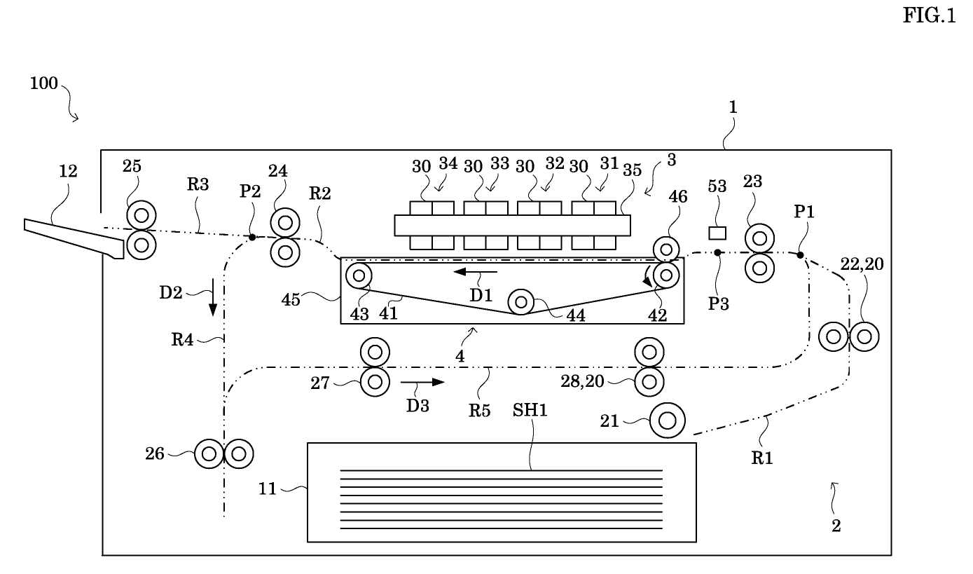

First, the configuration of an image forming apparatus 100 according to the embodiment of this disclosure will be described with reference to FIGS. 1-4. It is noted that FIG. 1 shows sheet conveyance paths R1 to R5 using two-dot chain lines.

The image forming apparatus 100 is a printer capable of forming images on both sides of a sheet SH1 (see FIG. 1) in an inkjet scheme. It is noted that this disclosure may be applied to an image forming apparatus such as a facsimile apparatus, a copier, and a multifunction peripheral capable of forming an image in the inkjet scheme. In addition, this disclosure may be applied to an image forming apparatus capable of forming an image in an image forming scheme such as electrophotography different from the inkjet scheme.

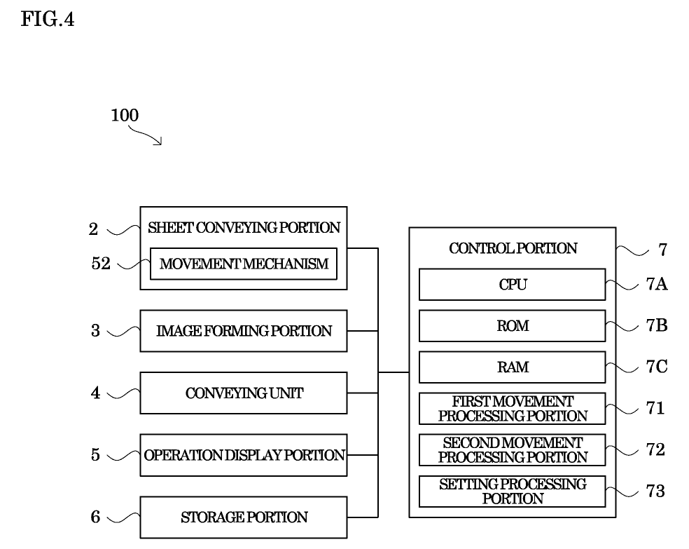

As shown in FIGS. 1 and 4, the image forming apparatus 100 includes a housing 1, a sheet conveying portion 2, an image forming portion 3, a conveying unit 4, an operation display portion 5, a storage portion 6, and a control portion 7.

The housing 1 stores the respective components of the image forming apparatus 100. The housing 1 is detachably provided with a sheet feed cassette 11 (see FIG. 1). The sheet feed cassette 11 stores the sheet SH1 on which an image is formed. For example, the sheets SH1 stored in the sheet feed cassette 11 are sheet materials such as paper, coated paper, postcard paper, an envelope, and an OHP sheet. The outside surface of the housing 1 is provided with a sheet discharge tray 12 (see FIG. 1). The sheet SH1 on which an image is formed by the image forming portion 3 is discharged to the sheet discharge tray 12.

The sheet conveyance paths R1 to R5 that guide the sheet SH1 conveyed by the sheet conveying portion 2 are provided inside the housing 1. The sheet conveyance path R1 is a movement path of the sheet SH1 extending from the sheet feed cassette 11 to a merge position P1 (see FIG. 1). The sheet conveyance path R2 is a movement path of the sheet SH1 extending from the merge position P1 to a branch position P2 (see FIG. 1) through an image forming position by the image forming portion 3. The sheet conveyance path R3 is a movement path of the sheet SH1 extending from the branch position P2 to the sheet discharge tray 12. The sheet conveyance path R4 is a movement path of the sheet SH1 extending from the branch position P2 through a second conveying roller pair 26. The sheet conveyance path R4 is used to invert the sheet SH1 on one side of which an image is formed by the image forming portion 3. The sheet conveyance path R5 is a movement path of the sheet SH1 that branches from the sheet conveyance path R4 and extends to the merge position P1. The sheet conveyance path R5 is used to reconvey the sheet SH1 inverted using the sheet conveyance path R4 to the image forming portion 3. The sheet conveyance path R2 is an example of a conveyance path according to this disclosure.

In the sheet conveyance path R1, the sheet conveyance path R2, and the sheet conveyance path R3, the sheet SH1 is conveyed in a conveyance direction D1 shown in FIG. 1. In the sheet conveyance path R4, the sheet SH1 is conveyed along a conveyance direction D2 shown in FIG. 1. In the sheet conveyance path R5, the sheet SH1 is conveyed in a conveyance direction D3 shown in FIG. 1.

The sheet conveying portion 2 conveys the sheet SH1 inside the housing 1. As shown in FIG. 1, the sheet conveying portion 2 includes a pickup roller 21, a first supply roller pair 22, a correction roller pair 23, a first conveying roller pair 24, a discharge roller pair 25, the second conveying roller pair 26, a third conveying roller pair 27, and a second supply roller pair 28.

The pickup roller 21 picks up the sheets SH1 from the sheet feed cassette 11 one by one and feeds the sheets SH1 to the sheet conveyance path R1. The first supply roller pair 22 is provided in the sheet conveyance path R1. The first supply roller pair 22 supplies the sheet SH1 that has not yet passed through the image forming position to the sheet conveyance path R2.

The correction roller pair 23 is provided in the sheet conveyance path R2. The correction roller pair 23 nips and conveys the sheet SH1 in the conveyance direction D1. The first conveying roller pair 24 is provided in the sheet conveyance path R2. The first conveying roller pair 24 nips and conveys the sheet SH1 in the conveyance direction D1.

The discharge roller pair 25 is provided in the sheet conveyance path R3. The discharge roller pair 25 discharges the sheet SH1 to the sheet discharge tray 12.

The second conveying roller pair 26 is provided in the sheet conveyance path R4. The second conveying roller pair 26 nips and conveys the sheet SH1 in the conveyance direction D2. After that, the second conveying roller pair 26 conveys the sheet SH1 in the direction opposite to the conveyance direction D2 and feeds the sheet SH1 to the sheet conveyance path R5.

The third conveying roller pair 27 is provided in the sheet conveyance path R5. The third conveying roller pair 27 nips and conveys the sheet SH1 in the conveyance direction D3. The second supply roller pair 28 is provided in the sheet conveyance path R5. The second supply roller pair 28 supplies the sheet SH1 inverted after passing through the image forming position to the sheet conveyance path R2.

The image forming portion 3 forms an image on the sheet SH1. As shown in FIG. 1, the image forming portion 3 includes line heads 31 to 34 and a head frame 35.

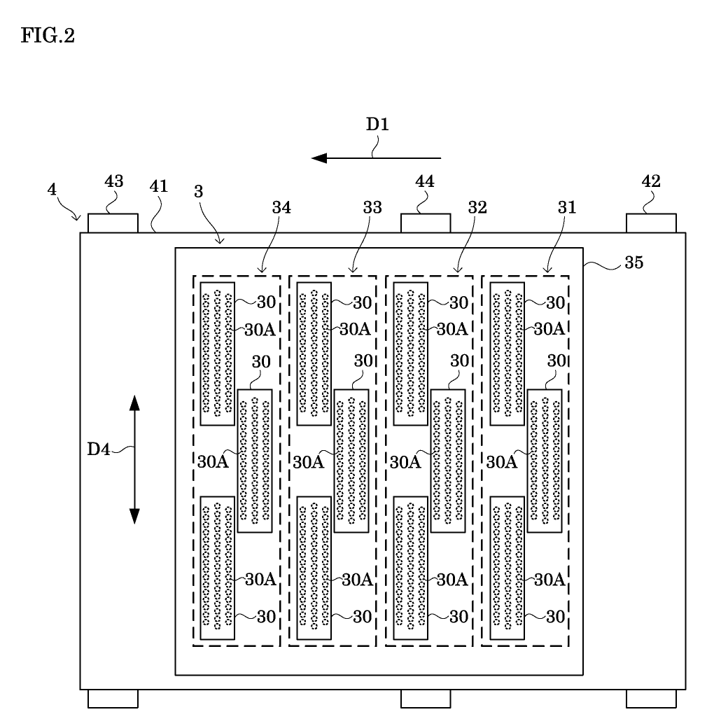

As shown in FIG. 2, each of the line heads 31 to 34 is long in a width direction D4 orthogonal to the conveyance direction D1. Specifically, each of the line heads 31 to 34 has the length corresponding to the width of the sheet SH1 having the maximum size in the width direction D4 among the sheets SH1 storable in the sheet feed cassette 11. The respective line heads 31 to 34 are provided side by side at even intervals along the conveyance direction D1.

As shown in FIG. 2, each of the line heads 31 to 34 includes a plurality of recording heads 30. Each of the recording heads 30 ejects ink to the sheet SH1 conveyed by the conveying unit 4. Each of the recording heads 30 provided to the line head 31 ejects black ink. Each of the recording heads 30 provided to the line head 32 ejects cyan ink. Each of the recording heads 30 provided to the line head 33 ejects magenta ink. Each of the recording heads 30 provided to the line head 34 ejects yellow ink.

Each of the recording heads 30 includes a plurality of nozzles 30A (see FIG. 2) each of which ejects ink. Each of the nozzles 30A is provided on the surface of each of the recording heads 30 opposed to the sheet SH1 conveyed by the conveying unit 4.

In addition, each of the recording heads 30 includes a pressurizing chamber (not shown), a piezoelectric element (not shown), and an individual channel (not shown) corresponding to each of the nozzles 30A. The pressurizing chamber communicates with the nozzle 30A and stores ink. The piezoelectric element causes the nozzle 30A to eject ink in response to the application of a drive voltage defined in advance. The individual channel is an ink channel provided between the pressurizing chamber and a common channel (not shown) common to the plurality of nozzles 30A. A plurality of the individual channels corresponding to the plurality of nozzles 30A is connected to the common channel. The common channel is connected to an ink supply portion (not shown) that supplies ink to each of the pressurizing chambers.

In this embodiment, the line head 31 has the three recording heads 30 arranged in a staggered pattern along the width direction D4. In addition, each of the other line heads 32 to 34 also has the three recording heads 30 arranged in a staggered pattern along the width direction D4 as with the line head 31.

The head frame 35 supports the line heads 31 to 34. The head frame 35 is supported by the housing 1. It is noted that the number of line heads provided to the image forming portion 3 does not have to be four. In addition, the number of recording heads 30 provided to each of the line heads 31 to 34 does not have to be three.

As shown in FIG. 1, the conveying unit 4 is disposed below the line heads 31 to 34. The conveying unit 4 conveys the sheet SH1 while opposing the sheet SH1 to the recording heads 30. As shown in FIG. 1, the conveying unit 4 includes a conveying belt 41 on which the sheet SH1 is placed, a first tension roller 42, a second tension roller 43, a third tension roller 44, and a conveyance frame 45. The first tension roller 42, the second tension roller 43, and the third tension roller 44 apply tension to the conveying belt 41. The conveyance frame 45 supports them. It is noted that the gap between the conveying belt 41 and the recording heads 30 is adjusted to cause the gap between the surface of the sheet SH1 and the recording heads 30 to have a predetermined distance (e.g., 1 mm) at the time of image formation.

The first tension roller 42 is rotationally driven by rotational driving force supplied from an unillustrated motor. This rotates the conveying belt 41 in a direction that allows the sheet SH1 to be conveyed in the conveyance direction D1 (see FIG. 1). It is noted that the conveying unit 4 is provided with a suction unit (not shown) or the like to cause the conveying belt 41 to adsorb the sheet SH1. The suction unit takes in air from a large number of through holes formed in the conveying belt 41. In addition, there is provided a pressure roller 46 on the upper side of the first tension roller 42. The pressure roller 46 presses the sheet SH1 against the conveying belt 41 for conveyance.

The operation display portion 5 is a user interface for the image forming apparatus 100. The operation display portion 5 includes a display portion and an operation portion. The display portion displays various kinds of information in response to a control instruction from the control portion 7. For example, the display portion is a display device such as a liquid-crystal display. The operation portion inputs various kinds of information to the control portion 7 in response to an operation of a user. For example, the operation portion is an operation device including an operation key and a touch panel.

The storage portion 6 is a non-volatile storage device. For example, the storage portion 6 is a flash memory.

The control portion 7 centrally controls the image forming apparatus 100. As shown in FIG. 4, the control portion 7 includes a CPU 7A, a ROM 7B, and a RAM 7C. The CPU 7A is a processor that executes various calculation processes. The ROM 7B is a non-volatile storage device that stores in advance information about control programs or the like for causing the CPU 7A to execute various processes. The RAM 7C is a volatile or non-volatile storage device that is used as a temporary storage memory (work area) for the various processes which are executed by the CPU 7A. The CPU 7A centrally controls the image forming apparatus 100 by executing the various control programs stored in advance in the ROM 7B.

It is noted that the control portion 7 may be a control portion provided separately from a main control portion which centrally controls the image forming apparatus 100. In addition, the control portion 7 may be composed of an electronic circuit such as an integrated circuit (ASIC).

The image forming apparatus 100 executes a single-sided image formation process of forming an image on one side of the sheet SH1 in response to an operation of a user on the operation display portion 5.

In a case where the single-sided image formation process is executed, the first supply roller pair 22 of the image forming apparatus 100 functions as a supply portion 20 (see FIG. 1). The supply portion 20 periodically supplies the sheet SH1 to the sheet conveyance path R2.

In addition, the image forming apparatus 100 executes a double-sided image formation process of forming images on both sides of the sheet SH1 in response to an operation of a user on the operation display portion 5.

In a case where the double-sided image formation process is executed, the first supply roller pair 22 and the second supply roller pair 28 of the image forming apparatus 100 each function as a supply portion 20.

Specifically, the first supply roller pair 22 sequentially supplies the sheets SH1 fed from the sheet feed cassette 11 to the sheet conveyance path R2 until the sheet SH1 on one side of which an image is formed reaches the second supply roller pair 28 after the time of the start of the double-sided image formation process. After an image is formed at the image forming position on each of the sheets SH1 supplied to the sheet conveyance path R2 by the first supply roller pair 22, the sheet SH1 is inverted in the sheet conveyance path R4 and fed to the second supply roller pair 28. In addition, after the sheets SH1 on one side of each of which an image is formed reaches the second supply roller pair 28, the first supply roller pair 22 and the second supply roller pair 28 alternately supply the sheets SH1 to the sheet conveyance path R2. In addition, after the first supply roller pair 22 finishes supplying the sheets SH1, the second supply roller pair 28 sequentially supplies the sheets SH1 supplied by the first supply roller pair 22 to the sheet conveyance path R2. The first supply roller pair 22 is an example of a first supply portion according to this disclosure. The second supply roller pair 28 is an example of a second supply portion according to this disclosure.

Here, the correction roller pair 23 is used to adjust the position of the sheet SH1 in the width direction D4. The sheet SH1 is conveyed to the image forming position.

Specifically, the correction roller pair 23 is provided so as to be movable along the width direction D4 (see FIG. 2) orthogonal to the conveyance direction D1 on the upstream side of the image forming position in the sheet conveyance path R2 in the conveyance direction D1 of the sheet SH1. The correction roller pair 23 is an example of a conveying portion according to this disclosure.

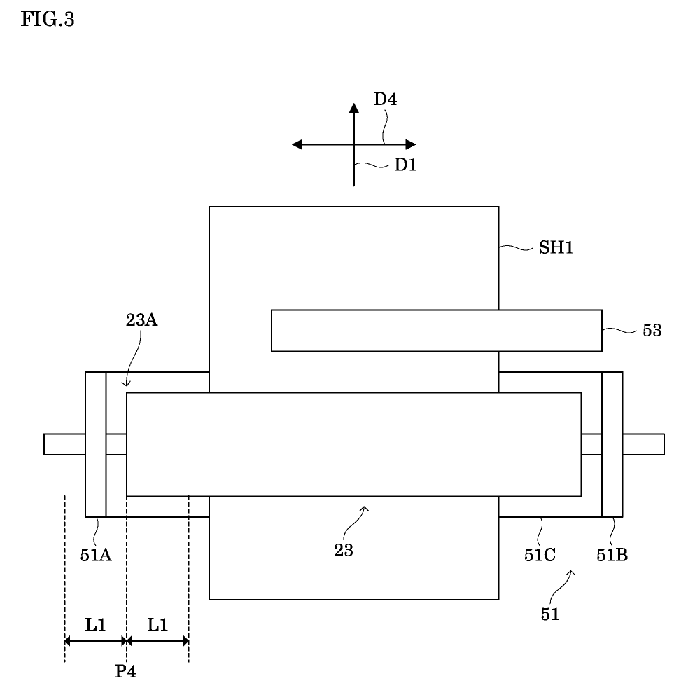

In addition, the sheet conveying portion 2 includes a support portion 51, a movement mechanism 52, and a sensing portion 53 shown in FIGS. 3 and 4.

The support portion 51 is provided so as to be movable along the width direction D4. The support portion 51 supports drive roller and driven roller included in the correction roller pair 23 to allow for rotation.

As shown in FIG. 3, the support portion 51 includes a first wall portion 51A, a second wall portion 51B, and a connection portion 51C. The first wall portion 51A is formed in the shape of a flat plate having thickness in the width direction D4. The first wall portion 51A supports one side of the rotation shaft of the drive roller in the width direction D4 and one side of the rotation shaft of the driven roller in the width direction D4 to allow for rotation. The second wall portion 51B is formed in the shape of a flat plate opposed to the first wall portion 51A in the width direction D4. The second wall portion 51B supports other side of the rotation shaft of the drive roller and other side of the rotation shaft of the driven roller to allow for rotation. The connection portion 51C is formed in the shape of a flat plate that is long in the width direction D4 and has thickness in the perpendicular direction. The first wall portion 51A and the second wall portion 51B are provided to stand on the respective ends of the connection portion 51C in the width direction D4.

The support portion 51 is supported by the housing 1 so as to be movable in the width direction D4. In addition, the correction roller pair 23 is provided so as to be movable integrally with the support portion 51. This moves even the correction roller pair 23 supported by the support portion 51 in the width direction D4 when the support portion 51 is moved in the width direction D4.

The correction roller pair 23 is provided to allow one end 23A (see FIG. 3) of the correction roller pair 23 in the width direction D4 to move from a reference position P4 (see FIG. 3) to both sides in the width direction D4 by a distance L1 (see FIG. 3).

The movement mechanism 52 moves the correction roller pair 23 along the width direction D4. Specifically, the movement mechanism 52 includes a motor that generates driving force which moves the correction roller pair 23 and the support portion 51 and a power transmission mechanism that transmits the driving force generated by the motor to the support portion 51. The support portion 51 is moved along the width direction D4 by the driving force transmitted from the movement mechanism 52.

The sensing portion 53 senses the position of the sheet SH1 in the width direction D4 before the back end of the sheet SH1 supplied by the supply portion 20 passes through the correction roller pair 23.

As shown in FIGS. 1 and 3, the sensing portion 53 is provided on the downstream side of the correction roller pair 23 in the sheet conveyance path R2 in the conveyance direction D1. It is noted that the sensing portion 53 may be provided on the upstream side of the correction roller pair 23 in the sheet conveyance path R2 in the conveyance direction D1.

Specifically, the sensing portion 53 is a contact image sensor (CIS) of capable of sensing the position of one end of the conveyed sheet SH1 in the width direction D4. In a case where the sheet SH1 passes through a sensing position P3 (see FIG. 1) by the sensing portion 53, the sensing portion 53 senses the position of one end of the sheet SH1 in the width direction D4 and outputs sensing result data indicating a result of the sensing. The sensing result data output from the sensing portion 53 is input to the control portion 7. It is noted that the sensing portion 53 may be reflective or transmissive optical sensors provided side by side along the width direction D4.

As described below, the control portion 7 adjusts the position of the sheet SH1 in the width direction D4 on the basis of the result of the sensing by the sensing portion 53. The sheet SH1 is conveyed to the image forming position.

### Functional Configuration of Control Portion 7

Next, the functional configuration of the control portion 7 will be described with reference to FIG. 4.

As shown in FIG. 4, the control portion 7 includes a first movement processing portion 71, a second movement processing portion 72, and a setting processing portion 73.

Specifically, the ROM 7B of the control portion 7 stores an operation control program in advance for causing the CPU 7A to function as each of the processing portions described above. The CPU 7A then functions as each of the processing portions described above by executing the operation control program stored in the ROM 7B.

It is noted that the operation control program may be recorded in a computer-readable recording medium such as a CD, a DVD, and a flash memory, and read from the recording medium and stored in a storage device such as the storage portion 6. In addition, some or all of the processing portions included in the control portion 7 may be each composed of an electronic circuit. In addition, the operation control program may be a program for causing a plurality of processors to function as the respective processing portions included in the control portion 7.

The first movement processing portion 71 moves the correction roller pair 23 that is nipping the sheet SH1 from the reference position P4 (see FIG. 3) within a movement range along the width direction D4 around the reference position P4 on the basis of the result of the sensing by the sensing portion 53.

Specifically, in a case where the sheet SH1 is supplied by the first supply roller pair 22 (see FIG. 1) while the single-sided image formation process is in execution, the first movement processing portion 71 moves the correction roller pair 23 that is nipping the sheet SH1 on the basis of a result of sensing by the sensing portion 53 obtained when the sheet SH1 passes through the correction roller pair 23.

More specifically, the first movement processing portion 71 calculates the amount of deviation in the position of the sheet SH1 from an ideal position defined in advance on the basis of the result of the sensing by the sensing portion 53. The first movement processing portion 71 then moves the correction roller pair 23 within the movement range to minimize the amount of deviation.

In addition, in a case where the sheet SH1 is supplied by the first supply roller pair 22 (see FIG. 1) while the double-sided image formation process is in execution, the first movement processing portion 71 does not move the correction roller pair 23 that is nipping the sheet SH1. In addition, in a case where the sheet SH1 is supplied by the second supply roller pair 28 (see FIG. 1) while the double-sided image formation process is in execution, the first movement processing portion 71 moves the correction roller pair 23 that is nipping the sheet SH1 on the basis of a result of sensing by the sensing portion 53 obtained when the sheet SH1 passes through the correction roller pair 23 for the first time and a result of sensing by the sensing portion 53 obtained when the sheet SH1 passes through the correction roller pair 23 again.

More specifically, the first movement processing portion 71 calculates the amount of deviation in the position of the sheet SH1 passing through the correction roller pair 23 again from the position of the sheet SH1 passing through the correction roller pair 23 for the first time on the basis of the result of the sensing by the sensing portion 53 obtained when the sheet SH1 passes through the correction roller pair 23 for the first time and the result of the sensing by the sensing portion 53 obtained when the sheet SH1 passes through the correction roller pair 23 again. The first movement processing portion 71 then moves the correction roller pair 23 within the movement range to minimize the amount of deviation.

The second movement processing portion 72 moves (returns) the correction roller pair 23 to the reference position P4 in a non-nipping period from the time when the correction roller pair 23 finishes nipping the sheet SH1 to the time when the correction roller pair 23 starts to nip the next sheet SH1.

The setting processing portion 73 sets a designation supply mode in response to a designation operation of designating any of a plurality of supply modes having the non-nipping periods different from each other.

Specifically, the setting processing portion 73 causes the operation display portion 5 to display a reception screen that is used to receive the designation operation in response to an operation on the operation display portion 5. The operation is defined in advance. In the reception screen, the designation operation for any of a first supply mode, a second supply mode, and a third supply mode is received.

Here, the first supply mode is the supply mode having the shortest non-nipping period. In addition, the second supply mode is the supply mode having the second shortest non-nipping period. In addition, the third supply mode is the supply mode having the longest non-nipping period.

For example, the first supply mode is the supply mode having the same conveyance speed of the sheet SH1 as those of the other supply modes and having the shortest supply period of the sheet SH1 by the supply portion 20. In addition, the second supply mode is the supply mode having the same conveyance speed of the sheet SH1 as those of the other supply modes and having the second shortest supply period of the sheet SH1 by the supply portion 20. In addition, the third supply mode is the supply mode having the same conveyance speed of the sheet SH1 as those of the other supply modes and having the longest supply period of the sheet SH1 by the supply portion 20.

It is noted that the first supply mode may be the supply mode having the same supply period of the sheet SH1 by the supply portion 20 as those of the other supply modes and having the lowest conveyance speed of the sheet SH1. In addition, the second supply mode may be the supply mode having the same supply period of the sheet SH1 by the supply portion 20 as those of the other supply modes and having the second lowest conveyance speed of the sheet SH1. In addition, the third supply mode may be the supply mode having the same supply period of the sheet SH1 by the supply portion 20 as those of the other supply modes and having the highest conveyance speed of the sheet SH1.

In addition, the supply period of the sheet SH1 by the supply portion 20 and the conveyance speed of the sheet SH1 in each of the supply modes may be freely defined.

In addition, the supply modes do not have to be limited to three in number.

The supply portion 20 periodically supplies the sheet SH1 in the designation supply mode designated in advance among a plurality of the supply modes.

It is noted that the designation supply mode may be set in advance to be unchangeable before the image forming apparatus 100 is shipped from the factory. In this case, the control portion 7 does not have to include the setting processing portion 73.

Incidentally, as the non-nipping period, that is, the conveyance interval between the sheets SH1, increases, the movable amount of the correction roller pair 23, that is, the adjustable amount of the position of each of the sheets SH1 in the width direction D4 at the time when the position of the sheet SH1 in the width direction D4 is adjusted grows larger in the image forming apparatus 100.

Conventionally, there has been, however, no component that switches the movement range of the correction roller pair 23 used to adjust the position of each of the sheets SH1 in the width direction D4 depending on the conveyance interval between the sheets SH1.

In contrast, the image forming apparatus 100 according to the embodiment of this disclosure allows the movement range of the correction roller pair 23 to be switched depending on the conveyance interval between the sheets SH1 as described below.

Specifically, a plurality of the movement ranges corresponding to a plurality of the supply modes is defined in advance in the image forming apparatus 100. That is, the three movement ranges (a first movement range, a second movement range, and a third movement range) corresponding to the three supply modes (the first supply mode, the second supply mode, and the third supply mode) are defined in advance.

The first movement range is the range from the reference position P4 to the first distance along the width direction D4. In addition, the second movement range is the range from the reference position P4 to a second distance greater than the first distance along the width direction D4. In addition, the third movement range is the range from the reference position P4 to a third distance greater than the second distance and less than or equal to the distance L1 (see FIG. 3) along the width direction D4.

That is, in the image forming apparatus 100, the relationship between a plurality of the supply modes and a plurality of the movement ranges is defined such that the movement ranges corresponding to the supply modes grow wider as the non-nipping periods corresponding to the supply modes increase.

The first movement processing portion 71 then moves the correction roller pair 23 that is nipping the sheet SH1 from the reference position P4 within the movement range corresponding to the designation supply mode among a plurality of the movement ranges corresponding to a plurality of the supply modes.

### First Movement Control Process

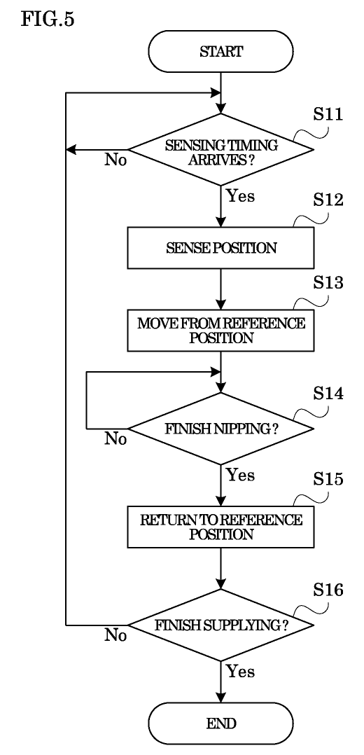

Next, an image forming method according to this disclosure will be described along with examples of procedures of a first movement control process that is executed by the control portion 7 in the image forming apparatus 100 with reference to FIG. 5. Here, steps S11, S12, ... denote the numbers of processing procedures (steps) that are executed by the control portion 7.

Additionally, in a case where the single-sided image formation process is executed by the image forming apparatus 100, the first movement control process is executed along with the single-sided image formation process. In the single-sided image formation process, the sheet SH1 is periodically supplied to the sheet conveyance path R2 by the supply portion 20.

### Step S11

First, in step S11, the control portion 7 determines whether or not the sensing timing of the position of the sheet SH1 arrives.

For example, in a case where the front end of the sheet SH1 is sensed by the sensing portion 53, the control portion 7 determines that the sensing timing arrives.

Here, when the control portion 7 determines that the sensing timing arrives (Yes in S11), the control portion 7 shifts the process to step S12. In addition, if the sensing timing has not yet arrived (No in S11), the control portion 7 waits for the arrival of the sensing timing in step S11.

### Step S12

In step S12, the control portion 7 senses the position of the sheet SH1 passing through the correction roller pair 23 in the width direction D4 using the sensing portion 53.

### Step S13

In step S13, the control portion 7 moves the correction roller pair 23 that is nipping the sheet SH1 from the reference position P4 within the movement range corresponding to the designation supply mode on the basis of a result of the process executed in step S12. The process of step S13 is an example of a first movement step according to this disclosure and is executed by the first movement processing portion 71 of the control portion 7.

Specifically, the control portion 7 calculates the amount of deviation in the position of the sheet SH1 from the ideal position on the basis of the result of the process executed in step S12. The control portion 7 then moves the correction roller pair 23 within the movement range to minimize the amount of deviation. Additionally, in a case where the calculated amount of deviation is zero, the control portion 7 does not have to move the correction roller pair 23.

### Step S14

In step S14, the control portion 7 determines whether or not the correction roller pair 23 finishes nipping the sheet SH1.

For example, in a case where the elapsed time from the arrival of the sensing timing exceeds a specific time defined in advance, the control portion 7 determines that the correction roller pair 23 finishes nipping the sheet SH1.

Here, when the control portion 7 determines that the correction roller pair 23 finishes nipping the sheet SH1 (Yes in S14), the control portion 7 shifts the process to step S15. In addition, if the correction roller pair 23 does not finish nipping the sheet SH1 (No in S14), the control portion 7 waits for the correction roller pair 23 to finish nipping the sheet SH1 in step S14.

### Step S15

In step S15, the control portion 7 moves (returns) the correction roller pair 23 to the reference position P4. The process of step S15 is an example of a second movement step according to this disclosure and is executed by the second movement processing portion 72 of the control portion 7.

### Step S16

In step S16, the control portion 7 determines whether or not the supply portion 20 finishes supplying the sheets SH1. That is, the control portion 7 determines whether or not all the sheets SH1 on which images are formed in the single-sided image formation process in execution are supplied by the supply portion 20.

Here, when the control portion 7 determines that the supply portion 20 finishes supplying the sheets SH1 (Yes in S16), the control portion 7 brings the first movement control process to an end. In addition, if the supply portion 20 does not finish supplying the sheets SH1 (No in S16), the control portion 7 shifts the process to step S11.

### Second Movement Control Process

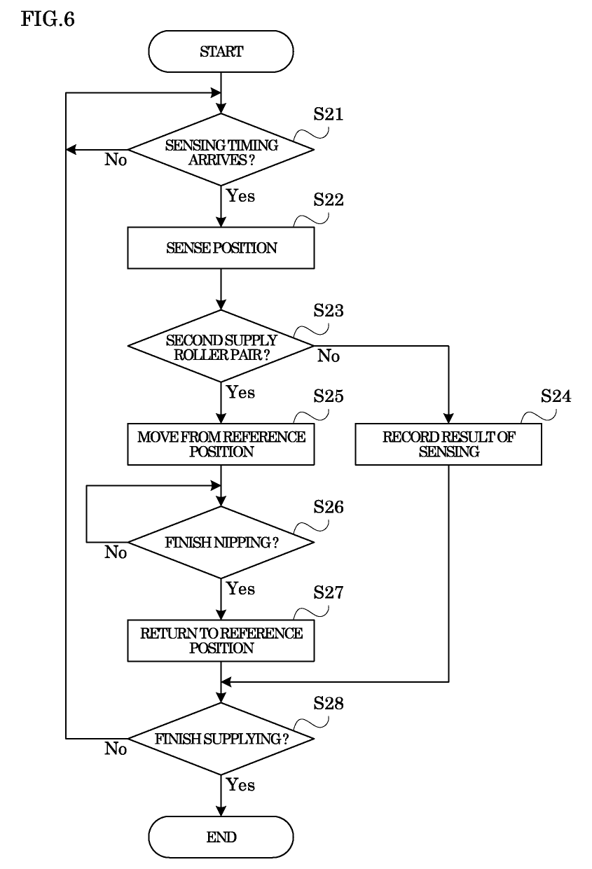

Next, examples of procedures of a second movement control process that is executed by the control portion 7 in the image forming apparatus 100 will be described with reference to FIG. 6.

Additionally, in a case where the double-sided image formation process is executed by the image forming apparatus 100, the second movement control process is executed along with the double-sided image formation process. In the double-sided image formation process, the sheet SH1 is periodically supplied to the sheet conveyance path R2 by the supply portion 20.

### Step S21

First, in step S21, the control portion 7 determines whether or not the sensing timing arrives using the same technique as that of the process of step S11 in the first movement control process.

Here, when the control portion 7 determines that the sensing timing arrives (Yes in S21), the control portion 7 shifts the process to step S22. In addition, if the sensing timing has not yet arrived (No in S21), the control portion 7 waits for the arrival of the sensing timing in step S21.

### Step S22

In step S22, the control portion 7 senses the position of the sheet SH1 passing through the correction roller pair 23 in the width direction D4 using the sensing portion 53.

### Step S23

In step S23, the control portion 7 determines whether or not the supply source of the sheet SH1 passing through the correction roller pair 23 is the second supply roller pair 28.

Here, when the control portion 7 determines that the supply source of the sheet SH1 is the second supply roller pair 28 (Yes in S23), the control portion 7 shifts the process to step S25. In addition, if the supply source of the sheet SH1 is not the second supply roller pair 28 (No in S23), the control portion 7 shifts the process to step S24.

### Step S24

In step S24, the control portion 7 records a result of the process of step S22.

For example, the control portion 7 stores the result of the process of step S22 in a data queue provided in advance.

### Step S25

In step S25, the control portion 7 moves the correction roller pair 23 that is nipping the sheet SH1 from the reference position P4 within the movement range corresponding to the designation supply mode on the basis of a result of the process of step S22 obtained when the sheet SH1 passing through the correction roller pair 23 passes through the correction roller pair 23 for the first time and a result of the process of immediately preceding step S22. The process of step S25 is another example of the first movement step according to this disclosure and is executed by the first movement processing portion 71 of the control portion 7.

Specifically, the control portion 7 calculates the amount of deviation in the position of the sheet SH1 passing through the correction roller pair 23 again from the position of the sheet SH1 passing through the correction roller pair 23 for the first time on the basis of data extracted from the data queue and indicating the result of the process of step S22 and the result of the process of immediately preceding step S22. The control portion 7 then moves the correction roller pair 23 within the movement range to minimize the amount of deviation. Additionally, in a case where the calculated amount of deviation is zero, the control portion 7 does not have to move the correction roller pair 23.

### Step S26

In step S26, the control portion 7 determines whether or not the correction roller pair 23 finishes nipping the sheet SH1 using the same technique as that of the process of step S14 in the first movement control process.

Here, when the control portion 7 determines that the correction roller pair 23 finishes nipping the sheet SH1 (Yes in S26), the control portion 7 shifts the process to step S27. In addition, if the correction roller pair 23 does not finish nipping the sheet SH1 (No in S26), the control portion 7 waits for the correction roller pair 23 to finish nipping the sheet SH1 in step S26.

### Step S27

In step S27, the control portion 7 moves (returns) the correction roller pair 23 to the reference position P4. The process of step S27 is another example of the second movement step according to this disclosure and is executed by the second movement processing portion 72 of the control portion 7.

### Step S28

In step S28, the control portion 7 determines whether or not the supply portion 20 finishes supplying the sheets SH1. That is, the control portion 7 determines whether or not all the sheets SH1 on which images are formed in the double-sided image formation process in execution are supplied by the supply portion 20.

Here, when the control portion 7 determines that the supply portion 20 finishes supplying the sheets SH1 (Yes in S28), the control portion 7 brings the second movement control process to an end. In addition, if the supply portion 20 does not finish supplying the sheets SH1 (No in S28), the control portion 7 shifts the process to step S21.

In this way, in the image forming apparatus 100, the correction roller pair 23 that is nipping the sheet SH1 is moved from the reference position P4 within the movement range corresponding to the designation supply mode among a plurality of the movement ranges corresponding to a plurality of the supply modes. This makes it possible to switch the movement range of the correction roller pair 23 depending on the conveyance interval between the sheets SH1.

### Supplementary Notes of Disclosure

The gist of the disclosure extracted from the embodiment described above will be supplementarily noted below. It is noted that the respective configurations and the respective processing functions described in the following supplementary notes can be sorted out and used in any combination.

### Supplementary Note 1

An image forming apparatus including:

an image forming portion configured to form an image on a sheet;

a conveying portion provided so as to be movable along a width direction on an upstream side of an image forming position by the image forming portion in a conveyance path of the sheet in a conveyance direction of the sheet, the conveyance path extending through the image forming position, the width direction being orthogonal to the conveyance direction, the conveying portion being configured to nip and convey the sheet;

a supply portion configured to periodically supply the sheet to the conveyance path;

a sensing portion configured to sense a position of the sheet in the width direction before a back end of the sheet supplied by the supply portion passes through the conveying portion;

a first movement processing portion configured to move the conveying portion that is nipping the sheet from a reference position defined in advance within a movement range along the width direction around the reference position on the basis of a result of sensing by the sensing portion; and

a second movement processing portion configured to move the conveying portion to the reference position in a non-nipping period from time when the conveying portion finishes nipping the sheet to time when the conveying portion starts to nip the next sheet, in which

the supply portion periodically supplies the sheet in a designation supply mode designated in advance among a plurality of supply modes having the non-nipping periods different from each other, and

the first movement processing portion moves the conveying portion that is nipping the sheet from the reference position within the movement range corresponding to the designation supply mode among a plurality of the movement ranges corresponding to a plurality of the supply modes.

### Supplementary Note 2

The image forming apparatus according to Supplementary Note 1, in which a relationship between a plurality of the supply modes and a plurality of the movement ranges is defined such that the movement ranges corresponding to the supply modes grow wider as the non-nipping periods corresponding to the supply modes increase.

### Supplementary Note 3

The image forming apparatus according to Supplementary Note 1 or 2, including a setting processing portion configured to set the designation supply mode in response to a designation operation of designating any of a plurality of the supply modes.

### Supplementary Note 4

The image forming apparatus according to any of Supplementary Notes 1 to 3, in which

the supply portion includes

a first supply portion configured to supply the sheet that has not yet passed through the image forming position, and

a second supply portion configured to supply the sheet inverted after passing through the image forming position, and

the first movement processing portion does not move the conveying portion that is nipping the sheet in a case where the sheet is supplied by the first supply portion while a double-sided image formation process of forming images on both sides of the sheet is in execution and the first movement processing portion moves the conveying portion that is nipping the sheet on the basis of a result of sensing by the sensing portion obtained when the sheet passes through the conveying portion for first time and a result of sensing by the sensing portion obtained when the sheet passes through the conveying portion again in a case where the sheet is supplied by the second supply portion.

### Supplementary Note 5

An image forming method that is executed by an image forming apparatus including an image forming portion, a conveying portion, a supply portion, and a sensing portion, the image forming portion being configured to form an image on a sheet, the conveying portion being provided so as to be movable along a width direction on an upstream side of an image forming position by the image forming portion in a conveyance path of the sheet in a conveyance direction of the sheet, the conveyance path extending through the image forming position, the width direction being orthogonal to the conveyance direction, the conveying portion being configured to nip and convey the sheet, the supply portion being configured to periodically supply the sheet to the conveyance path, the sensing portion being configured to sense a position of the sheet in the width direction before a back end of the sheet supplied by the supply portion passes through the conveying portion, the image forming method including:

a first movement step of moving the conveying portion that is nipping the sheet from a reference position defined in advance within a movement range along the width direction around the reference position on the basis of a result of sensing by the sensing portion; and

a second movement step of moving the conveying portion to the reference position in a non-nipping period from time when the conveying portion finishes nipping the sheet to time when the conveying portion starts to nip the next sheet, in which

the supply portion periodically supplies the sheet in a designation supply mode designated in advance among a plurality of supply modes having the non-nipping periods different from each other, and

the conveying portion that is nipping the sheet is moved in the first movement step from the reference position within the movement range corresponding to the designation supply mode among a plurality of the movement ranges corresponding to a plurality of the supply modes.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus comprising:
an image forming portion configured to form an image on a sheet;
a conveying portion provided so as to be movable along a width direction on an upstream side of an image forming position by the image forming portion in a conveyance path of the sheet in a conveyance direction of the sheet, the conveyance path extending through the image forming position, the width direction being orthogonal to the conveyance direction, the conveying portion being configured to nip and convey the sheet;
a supply portion configured to periodically supply the sheet to the conveyance path;
a sensing portion configured to sense a position of the sheet in the width direction before a back end of the sheet supplied by the supply portion passes through the conveying portion;
a first movement processing portion configured to move the conveying portion that is nipping the sheet from a reference position defined in advance within a movement range along the width direction around the reference position on a basis of a result of sensing by the sensing portion; and
a second movement processing portion configured to move the conveying portion to the reference position in a non-nipping period from time when the conveying portion finishes nipping the sheet to time when the conveying portion starts to nip the next sheet, wherein
the supply portion periodically supplies the sheet in a designation supply mode designated in advance among a plurality of supply modes having the non-nipping periods different from each other, and
the first movement processing portion moves the conveying portion that is nipping the sheet from the reference position within the movement range corresponding to the designation supply mode among a plurality of the movement ranges corresponding to a plurality of the supply modes.

2. The image forming apparatus according to claim 1, wherein a relationship between a plurality of the supply modes and a plurality of the movement ranges is defined such that the movement ranges corresponding to the supply modes grow wider as the non-nipping periods corresponding to the supply modes increase.

3. The image forming apparatus according to claim 1, comprising a setting processing portion configured to set the designation supply mode in response to a designation operation of designating any of a plurality of the supply modes.

4. The image forming apparatus according to claim 1, wherein
the supply portion includes
a first supply portion configured to supply the sheet that has not yet passed through the image forming position, and
a second supply portion configured to supply the sheet inverted after passing through the image forming position, and
the first movement processing portion does not move the conveying portion that is nipping the sheet in a case where the sheet is supplied by the first supply portion while a double-sided image formation process of forming images on both sides of the sheet is in execution and the first movement processing portion moves the conveying portion that is nipping the sheet on a basis of a result of sensing by the sensing portion obtained when the sheet passes through the conveying portion for first time and a result of sensing by the sensing portion obtained when the sheet passes through the conveying portion again in a case where the sheet is supplied by the second supply portion.

5. An image forming method that is executed by an image forming apparatus including an image forming portion, a conveying portion, a supply portion, and a sensing portion, the image forming portion being configured to form an image on a sheet, the conveying portion being provided so as to be movable along a width direction on an upstream side of an image forming position by the image forming portion in a conveyance path of the sheet in a conveyance direction of the sheet, the conveyance path extending through the image forming position, the width direction being orthogonal to the conveyance direction, the conveying portion being configured to nip and convey the sheet, the supply portion being configured to periodically supply the sheet to the conveyance path, the sensing portion being configured to sense a position of the sheet in the width direction before a back end of the sheet supplied by the supply portion passes through the conveying portion, the image forming method comprising:
a first movement step of moving the conveying portion that is nipping the sheet from a reference position defined in advance within a movement range along the width direction around the reference position on a basis of a result of sensing by the sensing portion; and
a second movement step of moving the conveying portion to the reference position in a non-nipping period from time when the conveying portion finishes nipping the sheet to time when the conveying portion starts to nip the next sheet, wherein
the supply portion periodically supplies the sheet in a designation supply mode designated in advance among a plurality of supply modes having the non-nipping periods different from each other, and
the conveying portion that is nipping the sheet is moved in the first movement step from the reference position within the movement range corresponding to the designation supply mode among a plurality of the movement ranges corresponding to a plurality of the supply modes.
